(19) United States
(12) Patent Application Publication
(10) Pub. No.: US 2022/0024220 A1
(43) Pub. Date: Jan. 27, 2022

(54) PROCESSING LIQUID, SET, METHOD OF PRINTING, AND PRINTING DEVICE

(71) Applicant: RICOH COMPANY, LTD., Tokyo (JP)

(72) Inventors: Masaki KUDO, Kanagawa (JP); Tomohiro HIRADE, Kanagawa (JP); Mio AKIMA, Tokyo (JP)

(21) Appl. No.: 17/381,585

(22) Filed: Jul. 21, 2021

(30) Foreign Application Priority Data
Jul. 27, 2020 (JP) 2020-126229

(51) Int. Cl. B41J 2/21; C09D 11/40; C09D 11/322; B41M 5/00; B41M 5/52

(52) U.S. Cl. CPC B41J 2/2117; C09D 11/40; C09D 11/322; B41M 5/5245; B41M 5/0064; B41M 5/5254; B41M 5/0017

(57) ABSTRACT

A processing liquid contains a nonionic resin, a resin particle having a carboxylic acid group, a flocculant, an organic solvent, and water.

### CROSS-REFERENCE TO RELATED APPLICATIONS

This patent application is based on and claims priority pursuant to 35 U.S.C. § 119 to Japanese Patent Application No. 2020-126229, filed on Jul. 27, 2020, in the Japan Patent Office, the entire disclosures of which is hereby incorporated by reference herein.

### BACKGROUND

### Technical Field

The present disclosure relates to a processing liquid, a set, a method of printing, and a printing device.

### Description of the Related Art

Inkjet printers are now a technology item not only for home use but also for forming images on packaging materials for food, beverages, and daily use items. Non-absorptive substrates such as plastic film are used as an inkjet applicable substrate.

For example, inkjet ink can be directly applied to plastic film which is used in package printing for food and items of daily use. Since such printed matter for package printing is viewed in a close range in many occasions, it requires extremely high image quality.

However, ink applied onto a non-absorptive substrate by inkjet printing does not permeate a substrate or dry therein. In fact ink droplets excessively spread, causing outline characters illegible, which is also referred to as “negative characters”. Such illegible outline characters are referred to as negative garbled characters.

In an attempt to solve this issue, a method of applying a processing liquid containing a flocculant first and then an ink containing a coloring material has been proposed.

In addition, customers and food companies request higher image quality and image density. If the amount of ink attached to a plastic film is increased to achieve a high image density, the ink does not dry on the film. Such ink has a large adverse impact on the productivity as a printer. This creates the problem regarding striking a balance between high image density and productivity.

### SUMMARY

According to embodiments of the present disclosure, provided is a processing liquid that contains a nonionic resin, a resin particle having a carboxylic acid group, a flocculant, an organic solvent, and water.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating a perspective view of an example of a printing device;

FIG. 2 is a diagram illustrating a perspective view of an example of the tank of a printing device; and

FIG. 3 is a schematic diagram illustrating an example of the printing device for using the processing liquid of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a processing liquid is provided which helps to produce print matter with high image density while the printed matter has excellent storage stability over a long period of time, good abrasion resistance, and good drying property and is free of negative garbled characters.

### Processing Liquid

The processing liquid of the present disclosure contains a nonionic resin, a resin particle containing a carboxylic acid group, a flocculant, an organic solvent, water, and other optional components. The processing liquid is substantially free of a coloring material. “Substantially free of a coloring material” means that no coloring material is actively added as a component of processing liquid. The processing liquid is also referred to as pre-processing liquid.

The present inventors have investigated long-term storage stability of resin particles under the presence of a flocculant and formulated the present disclosure of achieving such storage stability by using nonionic resin particles dispersed owing to steric effects, instead of generally used electric charge repulsive resin particles and cation resin particles.

Among the electric charge repulsive resin particles, anionic resin particles especially flocculates when mixed with a multi-valent metal salt. As the number of valence of a cation increases, the cation accelerates flocculation of such resin particles, resulting in salting-out of a large amount of dispersed matter. A multi-valent metal salt producing tri-valent cation is found to instantly aggregate at disassociation. Cationic resin particles are sufficiently stable when left at about room temperatures. However, if these are heated and left to stand as an acceleration test for long-terms stability, the cationic resin particles become sticky.

In the present disclosure, the processing liquid demonstrates excellent storage stability over a long period of time under the presence of the flocculant using the processing liquid containing a nonionic resin, resin particles having a carboxylic acid group, a flocculant, and water. In addition, printed matter with high image quality can be produced with this processing liquid. The printed matter has excellent abrasion resistance and drying property and is free of negative garbled characters.

Nonionic Resin

Since the nonionic resin in the present disclosure is dispersed owing to steric effects, it can be dispersed without electric charges.

The nonionic resin preferably takes a form of a nonionic resin particle. The nonionic resin particle means a resin particle free of a monomer having an acidic functional group such as a carboxyl group and sulfo group or a basic functional group such as an amino group as detected by thermal decomposition gas chromatography mass spectroscopy analysis (GC-MS) (for example, GC-17A, manufactured by SHIMADZU CORPORATION) after the solid content is isolated from a processing liquid by centrifugation.

The chemical structure of the nonionic resin particle is not particularly limited. Resin particles which can be nonion-dispersed can be used. It is preferable that the nonionic resin particle contain at least one of a polyolefin resin, polyvinyl acetate resin, polyvinyl chloride resin, polyurethane resin, styrene butadiene resin, and a copolymer of these resins to demonstrate strong attachability to various substrates. A copolymer resin of ethylene-vinyl acetate, copolymer resin of ethylene-vinyl acetate-vinyl chloride, or olefin-modified urethane resin is more preferable.

The glass transition temperature Tg of the nonionic resin particle is preferably from −30 to 30 degrees C. and more preferably from −25 to 25 degrees C.

A Tg of −30 degrees C. or higher forms a tough resin film formed of a processing liquid. A Tg of 30 degrees C. or lower enhances the filming property of resin and secures flexibility, thereby enhancing attachability to a substrate.

The nonionic resin can be procured. Specific examples include, but are not limited to, SUMIKAFLEX® 951HQ (ethylene-vinyl acetate resin, Tg of −25 degrees C., manufactured by Sumika Chemtex Company, Limited) and NALSTAR SR-130 (styrene-butadiene resin, Tg of −1 degrees C., manufactured by NIPPON A&L INC).

The proportion of the nonionic resin in the total amount of processing liquid is preferably from 0.5 to 20 percent by mass and more preferably from 1 to 15 percent by mass.

When the proportion is 0.5 percent by mass or more, the attachability is enhanced because the resin sufficiently covers a substrate. When the proportion is 20 percent by mass or less, the resin film formed of the processing liquid is not too thick, which does not create a concern about the degradation of attachability.

Resin Particle Having Carboxylic Acid Group

The resin particle having a carboxylic acid group is not particularly limited as long as it has a carboxylic acid group and can be suitably selected to suit to a particular application. Copolymer resin of acrylic acid and carboxylic acid is preferable.

The resin particle having a carboxylic acid group can be procured. Specific examples include, but are not limited to, B-300, B-300K, and B-500 (emulsion type acrylic-based thickener, manufactured by TOAGOSEI CO., LTD.), E-02 and E-03A (cross-linking agent for aqueous resin, manufactured by Nisshinbo Chemical Inc.), and LX851C and LX851E (acrylic-based latex, manufactured by Zeon Corporation).

The proportion of the resin particle having a carboxylic acid group in the total amount of the processing liquid is preferably from 0.01 to 2 percent by mass and more preferably from 0.05 to 1 percent by mass.

The processing liquid preferably contains resin particles other than the nonionic resin particle and resin particles having carboxylic acid group.

Other Resin Particle

The other resin particles contained in the processing liquid enhances attachability to a non-permeable substrate such as plastic film. In fact when white ink is dried on a substrate and is present physically close to resin particles, the white ink forms uniform film together with the resin particles owing to the mutual action attributable to the analogous structures thereof.

The other resin particles include, but are not limited to, polyurethane resin particles, acrylic urethane resin particles, polyolefin resin particles, polyester resin particles, and polyolefin-modified polyester urethane resins.

Method of Dispersing Resin Particle

It is preferable to use the resin particle as resin emulsion, which can be obtained by any known method.

The resin emulsion may optionally contain an organic solvent, an antiseptic agent, a leveling agent, an antioxidant, a light stabilizer, and an ultraviolet absorbent.

Moreover, a dispersant such as a surfactant can be optionally added to the resin particle. A so-called self-emulsification type emulsion is preferable to readily obtain ink having excellent applied film's performance. The processing liquid is not particularly limited as long as a desired viscosity is obtained because the processing liquid is discharged as droplets. It is preferable to use processing liquid in an emulsion state to secure storage stability.

The processing liquid may optionally contain a basic material to neutralize the acid component in resin particles and disperse them in water.

The basic material is not particularly limited and can be suitably selected to suit to a particular application.

Specific examples include, but are not limited to, sodium hydroxide, potassium hydroxide, ammonium, methyl amine, propyl amine, hexyl amine, octyl amine, ethanol amine, propanol amine, diethanol amine, N-methyl diethanol amine, dimethyl amine, diethyl amine, tri ethyl amine, N,N-dimethyl ethanol amine, 2-dimethylamino-2-methyl-1-propanol, 2-amino-2-methyl-1-propanol, and morpholine. These can be used alone or in combination. Of these, ammonium, triethyl amine, 2-amino-2-methyl-1-propanol, and morpholine are preferable.

The proportion of the basic material can be freely adjusted in accordance with the amount of the acid component of resin particles.

Flocculant

The flocculant includes a multi-valent metal salt and a cationic polymer.

Multi-Valent Metal Salt

When the multi-valent metal salt is at least one member selected from the group consisting of a calcium salt, a magnesium salt, a nickel salt, and an aluminum salt, negative garbled characters are reduced owing to excellent agglomeration effects of ink droplets and excellent storage stability is demonstrated, which is preferable.

The multi-valent metal salt is not particularly limited and can be suitably selected to suit to a particular application.

Specific examples include, but are not limited to, aluminum chloride, calcium chloride, nickel chloride, potassium acetate, sodium acetate, calcium acetate, magnesium acetate, aluminum nitrate, magnesium nitrate, magnesium chloride, calcium nitrate, magnesium hydroxide, aluminum sulfate, magnesium sulfate, and ammonium alum. These can be used alone or in combination. Of these, calcium acetate and calcium nitrate are preferable.

The proportion of the multi-valent metal salt in the total amount of the processing liquid is preferably from 1 to 30 percent by mass and more preferably from 5 to 20 percent by mass.

Cationic Polymer

As the cationic polymer, a water-soluble cationic polymer is suitably used which is obtained by copolymerizing an amine (amine monomer) and a monomer containing an epihalohydrin.

The water-soluble cationic polymer copolymerized from an amine monomer and a monomer containing an epihalohydrin has hydroxyl groups and ammonium cations in its main chain. The polymer isolates halogen anions in an aqueous solution, thereby enhancing buffer action or function of flocculating pigments when contacting inks.

A water-soluble cationic polymer is suitably selected as the cationic polymer from a polyamine-epihalohydrin copolymer, a polyamide-epihalohydrin copolymer, or a polyamide polyamine-epihalohydrin copolymer, and an amine-epihalohydrin copolymer.

More preferably, at least one of the copolymer represented by Chemical Formula 1 below, the copolymer represented by Chemical Formula 2 below, and the copolymer copolymerized from the amine monomer represented by Chemical Structure 3 below, the monomer represented by Chemical Structure 4, and the monomer represented by Chemical Formula 4 is used.

Specific examples of the amine monomer include, but are not limited to, diethylene triamine, triethylene tetraamine, tetraethylene pentaamine, and iminobis propyl amine. Of these, the monomer represented by Chemical Structure 3 is preferable because it is industrially manufactured and can be readily procured. Quaternary ammonium salt cationic polymers other than these compounds or water-dispersible cationic polymers can be cationic polymers in some occasions.

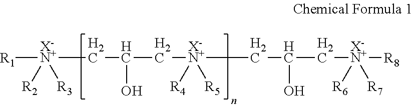

In Chemical Formula A, R₁ to R₈ represents an alkyl group, hydroxyalkyl group, alkenyl group, or benzyl group and X represents a halogen atom. n represents an integer of 1 or 2.

Specific examples of the halogen atom include, but are not limited to, a fluorine atom, a chlorine atom, a bromine atom, and an iodine atom.

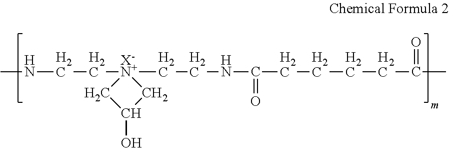

In Chemical Formula 2, X represents a halogen atom and m represents an integer of from 1 or more.

Specific examples of the halogen atom include, but are not limited to, a fluorine atom, a chlorine atom, a bromine atom, and an iodine atom.

The both terminals of the copolymer represented by Chemical Formula 2 can be those of a monomer constituting a repeating unit or a known initiator.

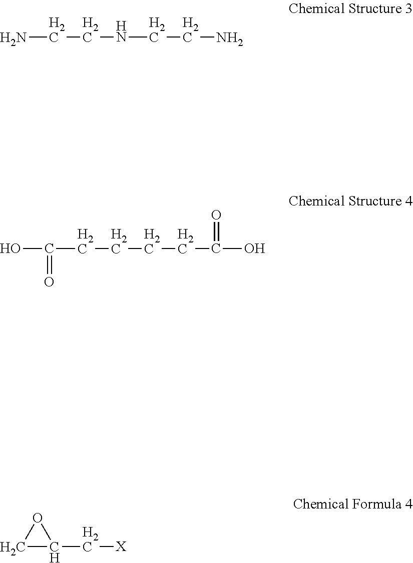

In Chemical Formula 4, X represents a halogen atom such as a fluorine atom, chlorine atom, bromine atom, and iodine atom.

The cationic polymer can be obtained by a method of polymerizing an amine monomer and a monomer containing epihalohydrin and a method of graft-polymerizing a monomer containing epihalohydrin to a polyamide obtained by polymerizing an amine monomer and a monomer containing a carboxylic acid.

The weight average molecular weight of the cationic polymer varies depending on the copolymer type. It is preferably from 500 to 100,000 in the case of polyamine and epihalohydrin copolymer. It is preferably from 1,000 to 5,000,000 in the case of polyamide-epihalohydrin copolymer or polyamidepolyamine-epihalohydrin copolymer. It is preferably from 700 to 50,000 in the case of amine-epihalohydrin copolymer.

When the weight average molecular weight surpasses each upper limit, processing liquid may not be an aqueous solution. Conversely, when the weight average molecular weight is below each bottom limit, the effect of using processing liquid may deteriorate.

The proportion of the cationic polymer in the total amount of processing liquid is preferably from 1 to 40 percent by mass and more preferably from 3 to 30 percent by mass.

A proportion of 40 percent by mass or greater does not enhance the image quality any more even when the proportion is increased. In fact, it may excessively increase viscosity of the processing liquid. When the proportion is less than 1 percent by mass, the effect of enhancing the quality of image may deteriorate.

Organic Solvent

There is no specific limitation on the type of the organic solvent used in the present disclosure. For example, water-soluble organic solvents are suitable. Examples of the water-soluble organic solvent are polyols, ethers such as polyol alkylethers and polyol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent having a boiling point of 250 or lower degrees C., which serves as a humectant and imparts a good drying property at the same time.

The proportion of the organic solvent is not particularly limited and can be suitably selected to suit to a particular application. In terms of the drying property and discharging reliability of processing liquid, the proportion in the processing liquid is preferably from 5 to 60 percent by mass, more preferably from 10 to 30 percent by mass in the total amount of the processing liquid, and furthermore preferably from 10 to 25 percent by mass.

When processing liquid contains 1,2-propane diol, 1,2-butane diol, or 2,3-butane diol, it enhances the film-forming property of resin and the abrasion resistance of film formed of the processing liquid, which is preferable.

Water

There is no specific limitation to water and it can be suitably selected to suit to a particular application. For example, pure water and ultra pure water such as deionized water, ultrafiltered water, reverse osmosis water, and distilled water are suitable. These can be used alone or in combination.

The proportion of water in processing liquid is not particularly limited. It will suffice unless a flocculant precipitates in the processing liquid while the fluid is stored at an ambient temperature.

The processing liquid preferably contains an organic acid ammonium salt to enhance the quality of formed images.

Organic Acid Ammonium Salt

Specific examples include, but are not limited to, ammonium lactate, ammonium acetate, ammonium propionate, ammonium oxalate, ammonium tartrate, ammonium succinate (diammonium succinate), diammonium maronate, diammonium hydrogen citrate, hydrogen citrate, triammonium citrate, and ammonium L-glutaminate. These can be used alone or in combination. Of these, ammonium lactate and ammonium acetate are preferable in terms of solubility in water.

The proportion of the organic acid ammonium salt in the total amount of processing liquid is preferably from 1 to 20 percent by mass and more preferably from 3 to 10 percent by mass.

A proportion of 20 percent by mass or greater does not enhance the image quality any more even when the proportion is increased. In fact, it may excessively increase viscosity of the processing liquid. When the proportion is less than 1 percent by mass, the effect of enhancing the quality of image may deteriorate.

Other Components Examples of the other components in the processing liquid are surfactants, defoaming agents, preservatives and fungicides, corrosion inhibitors, and pH regulators.

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams. Specific examples of the perfluoroalkyl sulfonic acid compounds include, but are not limited to, perfluoroalkyl sulfonic acid and salts of perfluoroalkyl sulfonic acid. Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluoro-surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These surfactants can be used alone or in combination or two or more thereof.

Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to achieve the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Specific examples include, but are not limited to, acid sulfites and sodium thiosulfates.

pH Regulator

The pH regulator has no particular limit. It includes, but are not limited to, amines such as diethanol amine and triethanol amine.

The processing liquid can be prepared by mixing nonionic resin, resin particles having a carboxylic acid group, a flocculant, an organic solvent, and water followed by optional mixing with stirring. A stirrer using a normal stirring blade, a magnetic stirrer, a high performance disperser can be used for the mixing with stirring.

Property of Processing Liquid

Properties of the processing liquid are not particularly limited and can be suitably selected to suit to a particular application. For example, the viscosity and pH are preferable in the following ranges.

The viscosity of the processing liquid at 25 degrees C. is preferably from 5 to 20 mPa·s and more preferably from 5 to 15 mPa·s to achieve good dischargeability.

Viscosity can be measured by an instrument such as a rotatory viscometer (RE-550L, manufactured by TOKI SANGYO CO., LTD.).

The measuring conditions are as follows:
Standard cone rotor (1° 34′×R24)
Sample liquid amount: 1.2 mL
Rate of rotations: 50 rotations per minute (rpm)
25 degrees C.
Measuring time: three minutes.

pH of the processing liquid is preferably from 7 to 12 and more preferably from 8 to 11 to prevent corrosion of metal material in contact with liquid.

Set of Ink and Processing Liquid

The set of ink and processing liquid of the present disclosure contains the processing liquid of the present disclosure and at least one of white ink n non-white ink.

The white ink preferably contains white coloring material and thermoplastic resin particles.

The thermoplastic resin particle has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Printed matter with excellent abrasion resistance and image density can be obtained by using the set of the ink and processing liquid of the present disclosure.

Ink

The ink contains a coloring material and preferably resin particles and other optional components.

Coloring Material

The color of the ink is not particularly limited. For example, white ink and/or non-white ink can be used.

ISO-2469 regulation (JIS-8148 format) can be used as the criteria of the whiteness of white ink. In general, a material having a value of 70 or greater can be used as a white material. Specific examples of the coloring material for use in white ink include, but are not limited to, titanium oxide, iron oxide, tin oxide, zirconium oxide, and iron titanate (complex oxide of iron and titanium). White hollow particles are also preferable.

White hollow particles include hollow resin particles and hollow inorganic particles. The resin composition of such hollow resin particles include, but are not limited to, acrylic-based resins such as acrylic resins, styrene-acrylic resins, cross-linking styrene-acrylic resins, urethane-based resins, and maleic-based resins.

Specific examples of materials for use in the hollow inorganic particle include, but are not limited to, oxides, nitrides, oxynitrides of metal such as silicone, aluminum, titanium, strontium, and zirconium, and inorganic compounds such as various types of glasses and silica.

As the coloring material for use in white ink, metal oxide enhances whiteness. White particles having a hollow structure is excellent about sedimentation, meaning not readily sedimented.

The non-white ink includes color ink, black ink, gray ink, metallic ink, and other inks. Specific examples of the color ink include, but are not limited to, cyan ink, magenta ink, yellow ink, light cyan ink, light magenta ink, red ink, green ink, blue ink, orange ink, and violet ink.

There is no specific limitation to the coloring material for use in the non-white ink as long as it shows non-white color. It can be suitably selected to suit to a particular application. For example, dyes and pigments are suitable. These can be used alone or in combination. Of these, pigments are preferable.

Examples of the pigment include, but are not limited to, organic pigments and inorganic pigments.

As the inorganic pigments, calcium oxide, barium sulfate, aluminum hydroxide, barium yellow, cadmium red, and chrome yellow, carbon black manufactured by known methods such as contact methods, furnace methods, and thermal methods can be used. These can be used alone or in combination.

Specific examples of the organic pigments include, but are not limited to, azo pigments (azo lakes, insoluble azo pigments, azo pigment condensates, chelate azo pigments, etc.), polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelate, acid dye type chelate), nitro pigments, nitroso pigments, and aniline black. These can be used alone or in combination.

Of those pigments, pigments having good affinity with solvents are preferable.

Specific examples of the pigment for black include, but are not limited to, carbon black (C.I. Pigment Black 7) such as furnace black, lamp black, acetylene black, and channel black, copper, iron (C.I. Pigment Black 11), and organic pigments such as aniline black (C.I. Pigment Black 1). These can be used alone or in combination.

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, and 155; C.I. Pigment Orange 5, 13, 16, 17, 36, 43, and 51; C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1, 4, 7, 8, 10, 17, 18, and 36. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35. These can be used alone or in combination.

As the coloring material for use in metallic ink, for example, a fine powder obtained by finely pulverizing a metal simple substance, an alloy, or a metal compound can be used. Specific examples include, but are not limited to at least one of a group of metal constituted of aluminum, silver, gold, nickel, chromium, tin, zinc, indium, titanium, silicon, copper, and platinum or alloys thereof.

Specific examples of the metal compound include, but are not limited to, oxides, nitrides, sulfide, or carbide of sole metal or alloys.

The proportion of the coloring material is preferably from 0.1 to 15 percent by mass and more preferably from 1 to 10 percent by mass in the total content of ink to enhance image density, fixability, and discharging stability.

The ink is obtained by a method of introducing a hydrophilic functional group into a pigment to prepare a self-dispersible pigment, a method of coating the surface of a pigment with a resin followed by dispersion, or a method of using a dispersant to disperse a pigment.

One way of preparing a self-dispersible pigment by introducing a hydrophilic functional group into a pigment is to add a functional group such as a sulfone group and carboxyl group to a pigment (e.g., carbon) to disperse the pigment in water.

One way of dispersing a resin by coating the surface thereof is to encapsulate a pigment in a microcapsule to make it disperse in water. The pigment obtained by this method can be also referred to as resin coated pigment.

In this case, all the pigments to be added to ink are not necessarily entirely coated with a resin. Pigments partially or entirely not coated with a resin may be dispersed in the ink unless such pigments have an adverse impact.

When a dispersant is used, a known dispersant having a small or large molecular weight, represented by a surfactant, is used.

Dispersants can be used in accordance with pigments.

Specific examples include, but are not limited to, anionic surfactants, cationic surfactants, amphoteric surfactants, and nonionic surfactants. In addition, RT-100 (manufactured by TAKEMOTO OIL & FAT CO., LTD.) and a formalin condensate of naphthalene sodium sulfonate are suitably used as the dispersant.

Those can be used alone or in combination.

Pigment Dispersion

It is possible to obtain an ink by mixing a coloring material with a material such as water and an organic solvent. It is also possible to mix a pigment with water, a dispersant, and other substances to prepare a pigment dispersion and thereafter mix the pigment dispersion with materials such as water and an organic solvent to manufacture an ink.

The pigment dispersion can be obtained by dispersing water, a pigment, a pigment dispersant, and other optional components and adjusting the particle size. It is preferable to use a dispersing device for dispersion.

The mean volume diameter of the pigment in the pigment dispersion has no particular limit. The average particle diameter of the non-white pigment is preferably from 30 to 110 nm. Within this range, dispersion stability and discharging stability of the pigment are enhanced and image quality such as image density ameliorates.

The mean volume diameter of metal oxide is preferably from 150 to 400 nm and more preferably from 200 to 300 nm to demonstrate high level of whiteness for white pigments.

The hollow resin particle preferably has a mean volume diameter of from 200 to 1,000 nm.

The mean volume diameter of such hollow inorganic particles is preferably from 10 to 200 nm. Within this range, excellent dispersion stability and a high level of whiteness are achieved.

The mean volume diameter of pigments can be measured by using a device such as a particle size analyzer (Nanotrac Wave-UT151, manufactured by MicrotracBEL Corp.).

The proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass. It is preferable that the pigment dispersion be filtered with an instrument such as filter and a centrifuge to remove coarse particles followed by deaerating.

Resin Particle

The resin particle is preferably a thermoplastic resin particle. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

It is possible to use suitably-synthesized resin particles as the resin particle. Alternatively, the resin particle is procurable. Specific examples of the procurable resin particle include, but are not limited to, Microgel E-1002 and E-5002 (styrene-acrylic-based resin particle, manufactured by Nippon Paint co., Ltd.), Voncoat 4001 (acrylic-based resin particle, manufactured by DIC Corporation), Voncoat 5454 (styrene/acrylic-based resin particle, manufactured by DIC Corporation), SAE-1014 (styrene-acrylic-based resin particle, manufactured by Nippon Zeon Co., Ltd.), Saivinol SK-200 (acrylic-based resin particle, manufactured by Saiden Chemical Industry Co., Ltd.), Primal AC-22 and AC-61 (acrylic-based resin particle, manufactured by The Dow Chemical Company), NANOCRYL SBCX-2821 and 3689 (acrylic-silicone-based resin particle, manufactured by Toyo Ink Co., Ltd.), and #3070 (methyl methacrylate polymer resin particle, manufactured by MIKUNI COLOR LTD.). Of these, acrylic silicone-based resins and polyurethane resins are preferable.

The volume average particle diameter (mean volume diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image robustness.

The mean volume diameter can be measured by using a device such as a particle size analyzer (Nanotrac Wave-UT151, manufactured by MicrotracBEL Corp.).

The proportion of the content of the resin is not particularly limited and can be suitably selected to suit to a particular application. It is preferably from 1 to 30 percent by mass and more preferably from 5 to 20 percent by mass of the total mass of the ink to secure fixability and storage stability of the ink.

The ink may optionally contain an organic solvent, a surfactant, and other additive like the processing liquid. Specific examples are the same as specified above.

The ink is manufactured by dispersing or dissolving the ink composition mentioned above in an aqueous medium followed by optional mixing and stirring. A stirrer using a normal stirring blade, a magnetic stirrer, a high performance disperser can be used for the mixing with stirring.

Property of Ink

Properties of the ink are not particularly limited and can be suitably selected to suit to a particular application; viscosity, surface tension, and pH are preferable in the following ranges.

The ink preferably has a viscosity of from 5 to 30 mPa·s and more preferably from 5 to 25 mPa·s at 25 degrees C. to enhance the print density and text quality and achieve a good di schargeability.

Viscosity can be measured by an instrument such as a rotatory viscometer (RE-80L, manufactured by TOKI SANGYO CO., LTD.).

The measuring conditions are as follows:
Standard cone rotor (1° 34′×R24)
Sample liquid amount: 1.2 mL
Rate of rotations: 50 rotations per minute (rpm)
25 degrees C.
Measuring time: three minutes.

The surface tension of the ink is preferably 35 mN/m or less and more preferably 32 mN/m or less at 25 degrees C. because the ink suitably levels on a substrate and the ink dries in a shorter time.

pH of the ink is preferably from 7 to 12 and more preferably from 8 to 11 to prevent corrosion of metal material in contact with liquid.

Substrate

The substrate for use in the present disclosure is not particularly limited and can be suitably selected to suit to a particular application. Plain paper, gloss paper, special paper, cloth, film, transparent sheets, printing for general purpose. Non-permeating substrate is particularly preferable.

The non-permeating substrate has a surface with poor moisture permeability, absorbency, and/or adsorptive property and includes a material having many hollow spaces inside that are not open to the outside.

To be more quantitative, the substrate has a water-absorbency of 10 mL/m² or less between the initiation of contact and 30 msec^{1/2} later according to Bristow's method.

Of the non-permeating substrate, resin film is preferable. Polypropylene film, polyethylene terephthalate film, and nylon film are particularly preferable.

Specific examples of the polypropylene film include, but are not limited to, P2002, P2102, P2161, and P-4166, all manufactured by TOYOBO CO., LTD., PA-20, PA-30, and PA-20W, all manufactured by SunTox Co., Ltd., and FOA, FOS, and FOR, all manufactured by FUTAMURA CHEMICAL CO., LTD.

Specific examples of the polyethylene terephthalate film include, but are not limited to, E-5100 and E-5102, both manufactured by TOYOBO CO., LTD., P60 and P375, both manufactured by Toray Industries, Inc., and G2, G2P2, K, and SL, all manufactured by Teijin Dupont Film Japan Limited.

Specific examples of the nylon film include, but are not limited to, Harden films N-1100, N-1102, and N-1200, all manufactured by TOYOBO CO., LTD. and ON, NX, MS, and NK, all manufactured by UNITIKA LTD.

Method of Printing and Printing Device

The method of printing of the present disclosure includes a processing liquid application, an ink application, and other optional processes.

The printing device of the present disclosure includes a processing liquid application device, an ink application device, and other optional devices.

Processing Liquid Application and Processing Liquid Application Device

The processing liquid application is to apply the processing liquid in a set of ink and the processing liquid of the present disclosure. This application was executed by a processing liquid application device.

When the processing liquid used as pre-processing liquid is applied to a substrate followed by ink application, printed matter having high image density free of negative garbled characters is obtained, which is preferable.

There is no specific limit to the method of applying the pre-processing liquid and it can be suitably selected to suit to a particular application.

Specific examples include, but are not limited, an inkjet printing method, a blade coating method, a gravure coating method, a gravure offset coating method, a bar coating method, a roll coating method, a knife coating method, an air knife coating method, a comma coating method, a U comma coating method, an AKKU coating method, a smoothing coating method, a microgravure coating method, a reverse roll coating method, a four or five roll coating method, a dip coating method, a curtain coating method, a slide coating method, and a die coating method. Of these, the inkjet method is preferable.

Ink Application and Ink Application Device

The ink application is to apply the ink of a set of ink an processing liquid of the present disclosure by an ink application device. It is preferable to apply the ink to the substrate where the processing liquid is applied in the processing liquid application described above.

The method of applying ink is not particularly limited.

Specific examples include, but are not limited to, an inkjet printing method, blade coating method, gravure coating method, gravure offset coating method, bar coating method, roll coating method, knife coating method, air knife coating method, comma coating method, U comma coating method, AKKU coating method, smoothing coating method, micro gravure coating method, reverse roll coating method, four roll coating method, five roll coating method, dip coating method, curtain coating method, slide coating method, and die coating method. Of these, an inkjet method is preferable.

The ink application device includes a nozzle for discharging the ink of a set of ink and processing liquid of the present disclosure, multiple individual liquid chambers communicating with the nozzle, an inlet passage for flowing the ink into the individual liquid chambers, and an outlet passage for flowing the ink out from the individual liquid chambers to discharge the ink for printing and circulating the ink from the outlet passage to the inlet passage. The ink is preferably applied to the substrate where the processing liquid has been applied.

Although the ink containing a resin component tends to cause discharging disturbance due to variance over time, high quality images free of image defects such as discharging disturbance can be produced with high productivity.

It is preferable to apply heat after the ink application.

The heating temperature is preferably from 30 to 100 degrees C. and more preferably from 60 to 80 degrees C. to sufficiently dry the ink by the heating without damaging a substrate.

The heating time is preferably from 10 seconds to 10 minutes and more preferably from one to two minutes to sufficiently dry the ink by the heating without damaging a substrate.

When non-white ink and white ink are used as the ink, the non-white ink is applied first and then the white ink is applied or the white ink is applied first and then the non-white ink is applied.

It is preferable to conduct heating after the application of the non-white ink and the application of the white ink.

The printing device of the present disclosure includes a discharging head for discharging the ink and the processing liquid of a set of ink and the processing liquid of the present disclosure.

The discharging head includes a nozzle for discharging ink or processing liquid, multiple individual liquid chambers communicating with the nozzle, an inlet passage for flowing the ink into the individual liquid chambers, and optionally preferably a circulation device for circulating the ink or the processing liquid from the outlet passage to the inlet passage.

The ink for use in the present disclosure can be suitably applied to various recording devices employing an inkjet recording method, such as printers, facsimile machines, photocopiers, multifunction peripherals (serving as a printer, a facsimile machine, and a photocopier), and solid freeform fabrication devices such as 3D printers and additive manufacturing devices.

In the present disclosure, the recording (printing) device and the recording (printing) method respectively represent a device capable of attaching ink and the processing liquid of the present disclosure to a substrate and a method of recording with the recording device.

The substrate means an item to which ink or various processing liquids can be temporarily or permanently attached.

In addition to the device for attaching processing liquid and the head portion for discharging the ink, the recording device may further optionally include a device relating to feeding, conveying, and ejecting a recording medium and other devices referred to as a pre-processing device and a post-processing device.

The recording device and the recording method may further optionally include a heating device (heater) for use in the heating process and a drying device (drier) for use in the drying process.

The heating device and the drying device heat and dry the print surface and the opposite surface of a substrate.

The heating device and the drying device are not particularly limited. For example, a fan heater and an infra-red heater can be used.

Heating and drying can be conducted before, in the middle of, or after printing.

In addition, the recording device and the recording method are not limited to those producing meaningful visible images such as text and figures with ink.

For example, the recording method and the recording device capable of producing patterns like geometric design and 3D images are included.

In addition, the recording device includes both a serial type device in which the discharging head moves and a line type device in which the discharging head is not moved, unless otherwise specified.

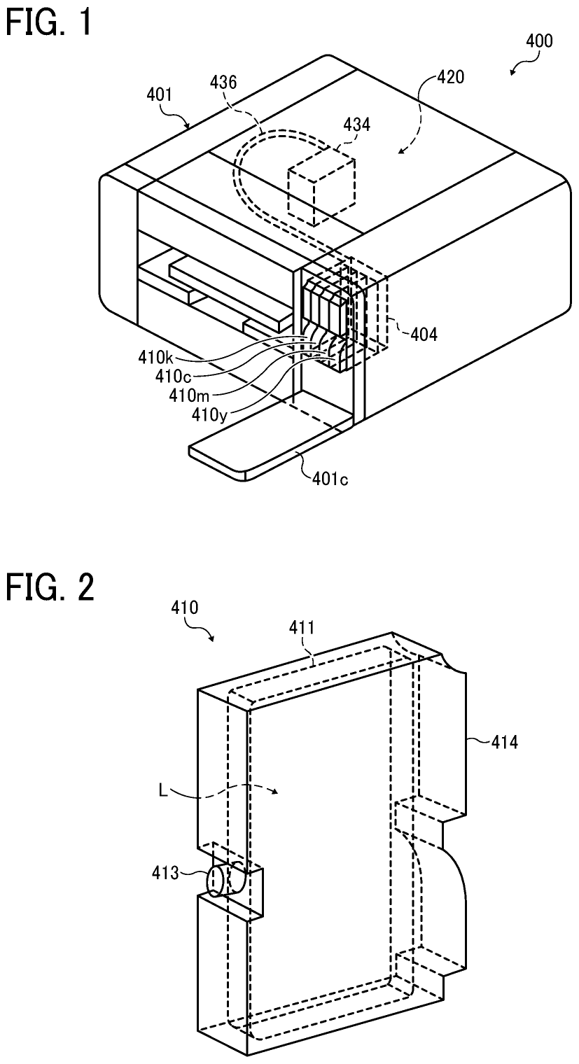

The recording device is described using an example with reference to FIG. 1 and FIG. 2. FIG. 1 is a diagram illustrating a perspective view of the image forming apparatus. FIG. 2 is a diagram illustrating a perspective view of a tank. An image forming apparatus 400 as an embodiment of the recording device is a serial type image forming apparatus. A mechanical unit 420 is disposed in an exterior 401 of the image forming apparatus 400. Each ink accommodating unit (ink container) 411 of each tank 410 (410k, 410c, 410m, and 410y) for each color of black (K), cyan (C), magenta (M), and yellow (Y) is made of, for example, packaging material such as aluminum laminate film. The ink accommodating unit 411 is housed in, for example, a plastic container housing unit 414 and L represents liquid contained in the ink accommodating unit 411. As a result, the tank 410 is used as an ink cartridge of each color. The same applies to white ink.

A cartridge holder 404 is disposed on the rear side of the opening appearing when a cover 401c is opened. The tank 410 is detachably attached to the cartridge holder 404. In this configuration, each ink discharging outlet 413 of the tank 410 communicates with a discharging head 434 for each color via a supplying tube 436 for each color and the ink can be discharged from the discharging head 434 to a recording medium.

This recording device may include not only a portion for discharging ink but also a device referred to as a pre-processing device and a post-processing device.

As an example of the pre-processing device and the post-processing device, like the case of the ink of black (K), cyan (C), magenta (M), and yellow (Y) ink, the pre-processing device and the post-processing device may further include a liquid accommodating unit including a processing liquid or a post-processing liquid and a liquid discharging head for discharging the processing liquid or the post-processing liquid according to an inkjet printing method.

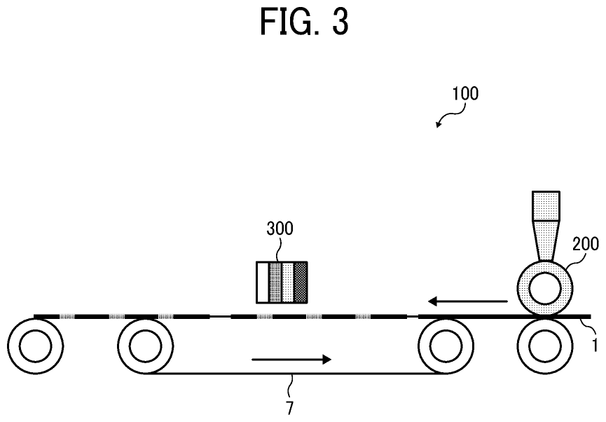

As another example of the pre-processing device and the post-processing device, it is possible to dispose a pre-processing device and a post-processing device which do not employ the inkjet printing method but a blade coating method, a roll coating method, or a spray coating method. FIG. 3 is a schematic diagram illustrating an example of the printing device using the processing fluid of the present disclosure. A printing device 100 includes a processing liquid application device 200 and an ink application device 300. It prints an image on a substrate 1 fed by a conveyor belt 7.

Notably, the ink is applicable not only to the inkjet recording but can be widely applied in other methods. Specific examples of such methods other than the inkjet recording include, but are not limited to, blade coating methods, gravure coating methods, bar coating methods, roll coating methods, dip coating methods, curtain coating methods, slide coating methods, die coating methods, and spray coating methods.

The usage of the ink for use in the present disclosure is not particularly limited and can be suitably selected to suit to a particular application. For example, the ink can be used for printed matter, a paint, a coating material, and foundation. The ink can be used to produce two-dimensional text and images and furthermore used as a material for solid fabrication for manufacturing a solid fabrication object (or solid freeform fabrication object).

The solid fabrication apparatus to fabricate a solid fabrication object can be any known device with no particular limit. For example, the apparatus includes a container, supplying device, discharging device, drier of ink, and others. The solid fabrication object includes an object manufactured by repetitively coating ink. In addition, the solid fabrication object includes a mold-processed product manufactured by processing a structure having a substrate such as a recording medium to which the ink is applied. The mold-processed product is manufactured from recorded matter or a structure having a form such as a sheet-like form, and film-like form. by, processing such as heating drawing or punching. The molded processed product is suitably used for articles which are molded after surface-decorating. Examples are gauges or operation panels of vehicles, office machines, electric and electronic devices, cameras, etc.

Terms such as image forming, recording, printing, and print used in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Example of Synthesis of Cationic Polymer A-1

Copolymer of Amine-Epichlorohydrin

A total of 95.1 g of water and 131.8 g (0.8 mol) of an aqueous solution of trimethyl amine hydrochloric acid salt at 58 percent were charged in a four-necked flask equipped with a stirrer, a thermometer, a reflux condenser, and a nitrogen introducing tube. Next, 74.0 g (0.8 mol) of epichlorohydrine was dripped into the flask in three hours while being cooled down not to surpass 40 degrees C. in nitrogen gas atmosphere. After the dripping was complete, the resulting mixture was heated to 80 degrees C. and allowed to react in one hour. Thereafter, subsequent to being cooled down to 30 degrees C., 36.1 g (0.4 mol) of aqueous solution of dimethyl amine at 50 percent by mass and 14.8 g (0.2 mol) of calcium hydroxide were added. The resulting mixture was heated to 80 degrees C. and allowed to react in one hour. Thereafter, the reaction liquid was adjusted by hydrochloric acid and water in such a manner that pH was 4.0 and the concentration of solid content was 50 percent by mass to obtain cationic polymer A-1.

### Example of Synthesis of Cationic Polymer A-2

Copolymer of Amine-Epichlorohydrin

A total of 36.8 g of water, 157.6 g (0.8 mol) of aqueous solution of trimethyl amine at percent, and 36.1 g (0.4 mol) of aqueous solution of dimethyl amine at 50 percent, 7.3 g (0.1 mol) of diethylamine were charged in a four-necked flask (500 ml) equipped with a stirrer, a thermometer, a reflux condenser, and a nitrogen introducing tube. Next, 92.5 g (1.0 mol) of epichlorohydrine was dripped to the flask in four hours while being cooled down not to surpass degrees C. in nitrogen gas atmosphere. Thereafter, the resulting mixture was heated to 80 degrees C. and allowed to react in two hours. Thereafter, subsequent to being cooled down to degrees C., the reaction liquid was adjusted by sulfuric acid and water in such a manner that the pH thereof became 3.9 and the concentration of solid content was 50 percent by mass to obtain cationic polymer A-2.

### Example of Synthesis of Cationic Polymer A-3

Copolymer of Polyamideamine-Epichlorohydrin

A total of 495 g (4.8 mol) of diethylene triamine was charged in a four-necked flask (3 litter) equipped with a thermometer, a condenser, a stirrer, and a nitrogen introducing tube. Next, 877 g (6.0 mol) of adipic acid was added thereto while being stirred and then, the system was heated while purging the system of produced water to conduct reaction at 150 degrees C. for five hours. Thereafter, 1,000 g of water was gradually added thereto to obtain a liquid containing polyamide polyamine. This liquid had a solid content of 52.1 percent and a viscosity of 380 mPa·s at 25 degrees C. when the solid content was 50 percent by mass. A total of 100 g of the thus-obtained liquid containing polyamide polyamine (0.214 mol as amino group), 3.8 g of acetic acid (30 equivalent percent), and 4.3 g (15 equivalent percent) of aqueous solution of sodium hydroxide at 30 percent by mass were mixed and then 6.7 g of water was added to make the solids content 50 percent by mass.

Next, after 19.8 g (100 equivalent percent) of epichlorohydrine was dripped thereto at degrees C. in one hour and the system was held at the same temperature for one hour. Then, 0.8 g (2 equivalent percent) of sodium methabisulfite was added and the system was held at the same temperature for five hours from the initiation time of dripping epichlorohydrine

Thereafter, 1.1 g (10 equivalent percent) of sulfuric acid at 98 percent by mass and 127.0 g of water were added to make a solid content 30 percent by mass followed by heating to 75 degrees C. Moreover, the system was held at this temperature until the viscosity of the reaction liquid became 300 mPa·s at 25 degrees C. Thereafter, 40.5 g of water was added to make the solid content 26 percent followed by being cooled down to 25 degrees C. or lower. Thereafter, pH of the system was adjusted to 3.0 by sulfuric acid at 30 percent by mass followed by adjusting by formic acid at 88 percent by mass to make pH 3.0 to obtain cationic polymer A-3 having a solid concentration of 25.0 percent by mass and a viscosity of 51.6 mPa·s (solid content concentration of 15 percent by mass).

### Example of Synthesis of Cationic Polymer A-4

Copolymer of Amine-Epichlorohydrin

A total of 443.85 parts of water and 41.27 parts of diethylene triamine were charged in a four-necked flask (1 litter) equipped with a stirrer, a thermometer, a reflux condenser, and a nitrogen-introducing tube and 111.04 parts of epichlorohydrine was dripped thereto in a nitrogen atmosphere in 1.5 hours not to surpass 40 degrees C. Thereafter, 19.4 parts of octahydro-4,7-methanoindene-1(2),5(6)-dimethane amine was added thereto followed by stirring for 30 minutes. Thereafter, 18.51 parts of epichlorohydrine was dripped to the flask in 0.5 hours not to surpass 40 degrees C. and then, the system was heated to 70 degrees C. and maintained at the temperature for 1.5 hours.

Thereafter, aqueous solution of sodium hydride at 30 percent by mass was added to adjust pH of the system 7.5. The temperature of the system was maintained for 1.5 hours. pH of the system was adjusted to be 3.5 by aqueous solution of sulfuric acid at 30 percent by mass followed by cooling-down to complete the reaction. The thus-obtained reaction product was cationic polymer A-4 having a solid content of 30.2 percent by mass, a viscosity of 7.6 mPa·s (solids content concentration of 10 percent), and a pH of 3.9.

### Example of Synthesis of Cationic Polymer A-5

Copolymer of Amine-Epichlorohydrin

A total of 657.2 parts of water, 58.4 parts of triethylene tetraamine, and 108 parts of dimethyl amine at 50 percent were charged in a four-necked flask (1 litter) equipped with a stirrer, a thermometer, a reflux condenser, and a nitrogen-introducing tube. Thereafter, 192.4 parts of epichlorohydrin was dripped to the flask in a nitrogen atmosphere in 1.5 hours not to surpass 40 degrees C. and then, the system was heated to and maintained at 70 degrees C. for 1.5 hours.

Thereafter, an aqueous solution of sodium hydride at 30 percent was added to adjust the pH of the system 7.5. The system was maintained at 70 degrees C. for 1.5 hours followed by pH adjustment to 3.5 by an aqueous solution of sulfuric acid at 30 percent and cooled down to complete the reaction. The thus-obtained reaction product was cationic polymer A-5 having a solid content of 29.9 percent by mass, a viscosity of 20 cps (solid content concentration of 10 percent by mass), and a pH of 3.5.

### Preparation Example 1 of Nonionic Resin Particle Emulsion

Preparation of Ethylene Vinyl Acetate Resin Emulsion

A total of 1,061 g of PVA-217 (the degree of polymerization of 1,700, the degree of saponification of 88 mol percent, manufactured by KURARAY CO., LTD.), 19,440 g of deionized water, 12.7 g of L(+) sodium tartrate, 10.6 g of sodium acetate, and 0.4 g of ferrous chloride were loaded in a pressure tight autoclave (50 litter) equipped with a nitrogen introducing inlet, a thermometer, and a stirrer. The mixture was completely dissolved at 95 degrees C. and cooled down to 60 degrees C. followed by nitrogen replacement.

Thereafter, 22,360 g of vinyl acetate was loaded, ethylene was introduced under pressure until 45 kg/cm², and 1,000 g of an aqueous solution of hydrogen peroxide at 0.4 percent by mass was press-fitted in five hours followed by emulsion polymerization at 60 degrees C. pH at the initial polymerization stage was confirmed to be 5.2.

When the remaining amount of vinyl acetate reached 10 percent by mass, ethylene was released until the pressure of ethylene was 20 kg/cm² and 50 g of aqueous solution of hydrogen peroxide at 3 percent by mass was press-fitted to continue polymerization.

When the remaining amount of vinyl acetate monomer reached 1.5 percent by mass in the emulsion, ethylene was released followed by cooling down.

Subsequent to cooling down, pH was confirmed to be 4.8. Thereafter, 20 g of sodium hydrogen sulfite was added followed by purging of ethylene at 30 degrees C. at a reduced pressure of 100 mmHg for one hour.

The system's pressure was restored to atmospheric pressure by nitrogen. Thereafter, 10 g of t-butylhydroperoxide was added followed by stirring for two hours.

pH at the completion of the polymerization was confirmed to be 4.7.

The thus-obtained emulsion was filtered, and the solid content was adjusted to be 50 percent by mass to obtain ethylene-vinyl acetate resin emulsion A.

The glass transition temperature (Tg) of the thus-obtained ethylene-vinyl acetate resin emulsion A was 0 degrees C. as measured by differential scanning calorimetry (Thermo plus EV02/DSC, manufactured by Rigaku Corporation).

### Preparation Example 2 of Nonionic Resin Particle Emulsion

Preparation of Polyester Resin Emulsion A

A total of 1.4 mol of dicyclohexyl methane diisocyanate, 0.1 mol of diisocyanate compound obtained by reaction of 1 mol of a trimer of isocyanulate of 1,6-hexamethylene diisocyanate and ⅓ mol of polyethylene glycol monomethyl ether having a molecular weight of 1,000, and N-methyl-2-pyrrolidone at 15 percent by mass of the total mass were loaded to 1 mol of 1,6-hexane diol in a reaction flask for reaction at 90 degrees C. for two hours in a nitrogen atmosphere so that a prepolymer was obtained.

A total of 450 g of the thus-obtained prepolymer having a solid content of 85 percent by mass was dripped in 15 minutes to 600 g of water in which 0.2 g of silicone-based defoaming agent (SE-21, manufactured by Wacker Asahikasei Silicone Co., Ltd.) was dissolved. Subsequent to stirring at 25 degrees C. for 10 minutes, the compound represented by the Chemical Structure A, ethylenediamine, and adipic acid hydrazide were dripped to obtain a polyurethane resin emulsion A.

H₂N—C₃H₆—Si—(OC₂H₅)₃ Chemical Structure A

The Tg of the polyurethane resin emulsion A was 20 degrees C. as measured by differential scanning calorimeter (DSC) (Thermo plus EVO2/DSC, manufactured by Rigaku Corporation).

### Preparation Example 3 of Nonionic Resin Particle Emulsion

Preparation of Polyester Resin Emulsion A

First, 3.0 parts of hydroxyethyl cellulose (METOLOSE 60SH-50, manufactured by Shin-Etsu Chemical Co., Ltd.) and 30 parts of nonionic emulsifier (EMULGEN 1108, manufactured by Kao Corporation) in solid portion conversion were dissolved in 225 parts of water to prepare an emulsifier aqueous solution.

Next, 150 parts of polylacetic acid (VYLOECOL BE-450, manufactured by TOYOBO CO., LTD.) was dissolved in 300 parts of toluene in a reaction container equipped with a thermometer, a nitrogen introducing tube, a stirrer, and a condenser. After the emulsifier aqueous solution was added, the resulting solution was stirred and mixed at 45 degrees C. for 30 minutes for preliminary emulsification.

The preliminary emulsified matter was emulsified under a pressure of 300 kg/m² by a high pressure emulsifier (manufactured by Manton-Gaulin) to obtain a minute emulsified object.

This minute emulsified object was heated and distilled under a reduced pressure of 130 mmHg to remove toluene. Thereafter, the solid portion was adjusted to obtain a polyester emulsion having a solid content of 45 percent by mass, a pH of 2.4, and a particle diameter of 0.32 μm. Thereafter, pH was adjusted to 7.0 by ammonium water at 25 percent by mass.

Next, 0.6 parts of a thickening agent (PRIMAL™ ASE-60, manufactured by Rohm and Haas Japan) was added to this polyester emulsion, which was adjusted to have a solid portion of 40 percent by mass to obtain a polyester resin emulsion A.

The Tg of the polyester resin emulsion A was 0 degrees C. as measured by a differential scanning calorimeter (DSC) (Thermo plus EVO2/DSC, manufactured by Rigaku Corporation).

### Examples 1 to 8 and Comparative Examples 1 to 5

Preparation of Processing Liquid

The material shown in Tables 1 to 3 were stirred for one hour to obtain a uniform mixture. Thereafter, each of the thus-obtained liquid mixture was filtered with a polyvinilydene fluoride membrane filter having an average pore diameter of 5.0 μm with an increased pressure to remove coarse particles and dust. Thus, the processing liquids of Examples 1 to 8 and Comparative Examples 1 to 5 were prepared.

The obtained processing liquids were evaluated regarding storage stability in the following manner. The results are shown in Tables 1 to 3.

Storage Stability

Each processing liquid was stored in a sealed container at 70 degrees C. for 14 days. The pre-storage viscosity and post-storage viscosity of the processing liquid were measured at degrees C. by a rotatory viscometer (RE-550L, cone 1° 34′×R24, manufactured by TOKI SAN GYO CO., LTD.) to obtain the viscosity change ratio of the processing liquid according to the following relationship. The change ratio was rated according to the following criteria to evaluate the storage stability. A or B rated processing liquid is usable for practical purpose.

Viscosity change ratio (percent)={(post-storage viscosity)−(pre-storage viscosity)]/(pre-storage viscosity)}×100

Evaluation Criteria

A: greater than −5 percent to less than 5 percent
B: greater than −10 percent to −5 percent and 5 percent to less than 10 percent
C: not greater than −10 percent and not less than 10 percent

TABLE 1

| | | Example | | | | |
|---|---|---|---|---|---|---|
| | | 1 | 2 | 3 | 4 | 5 |
| Resin A | B-300 (manufactured by | 0.1 | | 0.8 | | 0.05 |
| (resin | TOAGOSEI CO., LTD.) | | | | | |
| particle | B-500 (manufactured by | | 0.2 | | 0.9 | |
| haying | TOAGOSEI CO., LTD.) | | | | | |
| carboxylic | | | | | | |
| acid group) | | | | | | |
| Resin for | PEO-8 (manufactured by | | | | | |
| comparison | SUMITOMO SEIKA | | | | | |
| with resin | CHEMICALS CO., LTD.) | | | | | |
| A | PEO-18 (manufactured by | | | | | |
| | SUMITOMO SElKA | | | | | |
| | CHEMICALS CO., LTD.) | | | | | |
| Resin B | Ethylene-vinyl acetate | 15 | 0.5 | | | |
| (nonionic | resin A (Tg: 0 degrees C.) | | | | | |
| resin) | Ethylene-vinyl acetate | | | 20 | | |
| | resin B (Tg: −25 degrees | | | | | |
| | C.) | | | | | |
| | Styrene-butadiene resin | | | | 21 | |
| | (Tg = −1 degrees C.) | | | | | |
| | Polyester resin A (Tg: 0 | | | | | 0.4 |
| | degrees C.) | | | | | |
| | Polyurethane resin A (Tg: | | | | | |
| | 20 degrees C.) | | | | | |
| Resin for | Anionic resin | | | | | |
| comparison | Cationic resin | | | | | |
| with resin | | | | | | |
| B | | | | | | |
| Organic acid | Ammonium lactate | 5 | 5 | 5 | 5 | |
| ammonium | Ammonium acetate | | | | | 5 |
| salt | | | | | | |
| multi-valent | Calcium nitrate | | | | | |
| metal salt | Calcium acetate | | | | | |
| Cationic | A-1 | 10 | | | | |
| polymer | A-2 | | 20 | | | |
| | A-3 | | | 10 | | |
| | A-4 | | | | 10 | |
| | A-5 | | | | | 15 |
| | WS-4020 | | | | | |
| Organic | 1,2-propane diol | 10 | 10 | 10 | 10 | |
| solvent | 1,2-butanediol | | | | | 15 |
| | 3-methoxy-3-methyl-1- | 2 | 2 | 2 | | 2 |
| | butanol | | | | | |
| Surfactant | FS-300 | 2 | 2 | 2 | | |
| Mildew- | Proxel GXL | 0.05 | 0.05 | 0.05 | 0.05 | 0.05 |
| proofing | | | | | | |
| agent | | | | | | |
| Defoaming | 2,4,7,9-tetramethyl | 0.5 | 0.5 | | | 0.4 |
| agent | decane-4,7-diol | | | | | |
| | 2,5,8,11-tetramethyl | | | 0.4 | 0.4 | |
| | dodecane-5,8-diol | | | | | |
| pH | 2-amino-2-ethyl-1,3- | 0.2 | 0.2 | 0.2 | 0.1 | 0.2 |
| regulator | propane diol | | | | | |
| Permeating | 2-ethyl-1,3-hexane diol | 0.3 | | 0.3 | 0.3 | 0.3 |
| agent | | | | | | |
| Water | Pure water | Balance | Balance | Balance | Balance | Balance |
| Total (percent by mass) | | 100 | 100 | 100 | 100 | 100 |
| Storage | Viscosity change ratio | 3.6 | 1.2 | 7.8 | 9.8 | −0.6 |
| Stability | | percent | percent | percent | percent | percent |
| | Evaluation | A | A | B | B | A |

TABLE 2

| | | Example | | |
|---|---|---|---|---|
| | | 6 | 7 | 8 |
| Resin A | B-300 (manufactured by TOAGOSEI CO., | | 0.1 | 0.1 |
| (resin | LTD.) | | | |
| particle | B-500 (manufactured by TOAGOSEI CO., | 0.04 | | |
| haying | LTD.) | | | |
| carboxylic | | | | |
| acid group) | | | | |
| Resin for | PEO-8 (manufactured by SUMITOMO | | | |
| comparison | SEIKA CHEMICALS CO LTD.) | | | |
| with resin A | PEO-18 (manufactured by SUMITOMO | | | |
| | SEIKA CHEMICALS CO., LTD.) | | | |
| Resin B | Ethylene-vinyl acetate resin A (Tg: 0 | | 15 | 15 |
| (nonionic | degrees C.) | | | |
| resin) | Ethylene-vinyl acetate resin B (Tg: −25 | | | |
| | degrees C.) | | | |
| | Styrene-butadiene resin (Tg = −1 degrees C.) | | | |
| | Polyester resin A (Tg: 0 degrees C.) | | | |
| | Polyurethane resin A (Tg: 20 degrees C.) | 10 | | |
| Resin for | Anionic resin | | | |
| comparison | Cationic resin | | | |
| with resin B | | | | |
| Organic acid | Ammonium lactate | 5 | 5 | |
| ammonium | Ammonium acetate | | | |
| salt | | | | |
| multi-valent | Calcium nitrate | | 20 | |
| metal salt | Calcium acetate | | | |
| Cationic | A-1 | | | 10 |
| polymer | A-2 | | | |
| | A-3 | | | |
| | A-4 | | | |
| | A-5 | | | |
| | WS-4020 | 15 | | |
| Organic | 1,2-propane diol | | 10 | 10 |
| solvent | 1,2-butanediol | 15 | | |
| | 3-methoxy-3-methyl-1-butanol | 2 | 2 | 2 |
| Surfactant | FS-300 | | 2 | 2 |
| Mildew- | Proxel GXL | 0.05 | 0.05 | 0.05 |
| proofing | | | | |
| agent | | | | |
| Defoaming | 2,4,7,9-tetramethyl decane-4,7-diol | 0.4 | 0.5 | 0.5 |
| agent | 2,5,8,11-tetramethyl dodecane-5,8-diol | | | |
| pH regulator | 2-amino-2-ethyl-1,3-propane diol | 0.2 | 0.2 | 0.2 |
| Permeating | 2-ethyl-1,3-hexane diol | 0.3 | 0.3 | 0.3 |
| agent | | | | |
| Water | Pure water | Balance | Balance | Balance |
| Total (percent by mass) | | 100 | 100 | 100 |
| Storage | Viscosity change ratio | 8.1 | 9.8 | 5.0 |
| Stability | | percent | percent | percent |
| | Evaluation | B | B | B |

TABLE 3

| | | Comparative Example | | | | |
|---|---|---|---|---|---|---|
| | | 1 | 2 | 3 | 4 | 5 |
| Resin A | B-300 (manufactured by | 0.1 | | | | 0.1 |
| (resin | TOAGOSEI CO., LTD.) | | | | | |
| particle | B-500 (manufactured by | | | | | |
| having | TOAGOSEI CO., LTD.) | | | | | |
| carboxylic | | | | | | |
| acid group) | | | | | | |
| Resin for | PEO-8 (manufactured by | | | 0.5 | | |
| comparison | SUMITOMO SEIKA | | | | | |
| with resin | CHEMICALS CO., LTD.) | | | | | |
| A | PEO-18 (manufactured by | | 0.1 | | 0.5 | |
| | SUMITOMO SEIKA | | | | | |
| | CHEMICALS CO., LTD.) | | | | | |
| Resin B | Ethylene-vinyl acetate | | | 15 | 15 | 15 |
| (nonionic | resin A (Tg: 0 degrees C.) | | | | | |
| resin) | Ethylene-vinyl acetate | | | | | |
| | resin B (Tg: −25 degrees | | | | | |
| | C.) | | | | | |
| | Styrene-butadiene resin | | | | | |
| | (Tg = −1 degrees C.) | | | | | |
| | Polyester resin A (Tg: 0 | | | | | |
| | degrees C.) | | | | | |
| | Polyurethane resin A (Tg: | | | | | |
| | 20 degrees C.) | | | | | |
| Resin for | Anionic resin | 10 | | | | |
| comparison | Cationic resin | | 10 | | | |
| with resin | | | | | | |
| B | | | | | | |
| Organic acid | Ammonium lactate | 5 | 5 | 5 | 5 | 5 |
| ammonium | Ammonium acetate | | | | | |
| salt | | | | | | |
| multi-valent | Calcium nitrate | | | 20 | | |
| metal salt | Calcium acetate | | | | 20 | |
| Cationic | A-1 | 10 | 10 | | | |
| polymer | A-2 | | | | | |
| | A-3 | | | | | |
| | A-4 | | | | | |
| | A-5 | | | | | |
| | WS-4020 | | | | | |
| Organic | 1,2-propane diol | 15 | | | | |
| solvent | 1,2-butanediol | | 10 | 5 | 5 | 5 |
| | 3-methoxy-3-methyl-1- | 2 | 2 | 2 | 2 | 2 |
| | butanol | | | | | |
| Surfactant | FS-300 | | | | | |
| Mildew- | Proxel GXL | 0.05 | 0.05 | 0.05 | 0.05 | 0.05 |
| proofing | | | | | | |
| agent | | | | | | |
| Defoaming | 2,4,7,9-tetramethyl | 0.4 | 0.4 | | 0.5 | 0.5 |
| agent | decane-4,7-diol | | | | | |
| | 2,5,8,11-tetramethyl | | | 0.4 | | |
| | dodecane-5,8-diol | | | | | |
| pH | 2-amino-2-ethyl-1,3- | 0.2 | 0.2 | 0.1 | 0.2 | 0.2 |
| regulator | propane diol | | | | | |
| Permeating | 2-ethyl-1,3-hexane diol | 0.3 | 0.3 | 0.3 | 0.3 | 0.3 |
| agent | | | | | | |
| Water | Pure water | Balance | Balance | Balance | Balance | 86.95 |
| Total (Percent by mass) | | 100 | 100 | 100 | 100 | 100 |
| Storage | Viscosity change ratio | −2.0 | 11.2 | −3.1 | 4.2 | 8.0 |
| Stability | | percent | percent | percent | percent | percent |
| | Evaluation | A | C | A | A | B |

The details of the individual ingredients in Tables 1 to 3 are as follows:

Resin A (resin particle having carboxylic acid group)
Resin particle having carboxylic acid group (B-300, manufactured by TOAGOSEI CO., LTD.)
Resin particle having carboxylic acid group (B-500, manufactured by TOAGOSEI CO., LTD.)

Resin for Comparison with Resin A
Water-soluble thermoplastic resin: PEO-8 (nonionic resin, manufactured by SUMITOMO SEIKA CHEMICALS CO., LTD.)
Water-soluble thermoplastic resin: PEO-18 (nonionic resin, manufactured by SUMITOMO SEIKA CHEMICALS CO., LTD.)

Resin B (nonionic resin)
Ethylene-vinyl acetate resin B: SUMIKAFLEX® 951HQ, Tg of −25 degrees C., manufactured by Sumika Chemtex Company, Limited
Styrene-butadiene resin: NALSTAR SR-130, Tg of −1 degrees C., manufactured by NIPPON A&L INC

Resin for Comparison with Resin B
Anionic resin: TAKELAC™ W-5661 (urethane resin, manufactured by Mitsui Chemicals, Inc.)
Cationic resin: ARROWBASE CB-1200 (polyolefin resin, manufactured by UNITIKA LTD.)

Organic Acid Ammonium Salt
Ammonium lactate (purity of 73 to 77 percent by mass, manufactured by Kanto Chemical Co., Inc.)
Ammonium acetate (purity of 97 percent by mass or greater, manufactured by Kanto Chemical Co., Inc.)

Cationic Resin
WS-4020 (polyamide-epichlorohydrin copolymer, effective component of 25 percent or greater, manufactured by SEIKO PMC CORPORATION)

Mildew-Proofing Agent
PROXEL GXL: mildew-proofing agent mainly composed of 1,2-benzisothiazolin-3-one (component: 20 percent by mass, containing dipropylene glycol, manufactured by Avecia)

Surfactant
FS-300 (fluorochemical surfactant, manufactured by E.I. du Pont de Nemours and Company)

### Manufacturing Example 1 of Pigment Dispersion

Preparation of Black Pigment Dispersion

A total of 100 g of carbon black (SEAST SP, SRF-LS, manufactured by TOKAI CARBON CO., LTD.) was added to 3,000 mL of sodium hypochlorite at 2.5 normal followed by stirring at 300 rpm at 60 degrees C. to allow reaction for 10 hours for oxidization. As a result, a pigment in which a carboxylic acid group was placed on the surface of carbon black was obtained.

The reaction liquid was filtered and the thus-filtered carbon black was neutralized with sodium hydroxide solution followed by ultra-filtering.

Thereafter, the thus-obtained pigment dispersion and deionized water were subjected to ultrafiltering by dialysis membrane and further ultrasonic dispersion to obtain black pigment dispersion having a pigment solid content concentrated to 20 percent by mass with a mean volume diameter of 100 nm.

### Manufacturing Example 2 of Pigment Dispersion

Preparation of Cyan Pigment Dispersion

A cyan pigment dispersion having a mean volume diameter of 62 nm was obtained in the same manner as in Manufacturing Example 1 of Pigment Dispersion except that carbon black was replaced with Hostaperm Blue B4G (manufactured by Clariant AG).

### Manufacturing Example 3 of Pigment Dispersion

Preparation of Magenta Pigment Dispersion

A magenta pigment dispersion having a mean volume diameter of 87 nm was obtained in the same manner as in Manufacturing Example 1 of Pigment Dispersion except that carbon black was replaced with Hostaperm Pink E02 (manufactured by Clariant AG).

### Manufacturing Example 4 of Pigment Dispersion

Preparation of Yellow Pigment Dispersion

A yellow pigment dispersion having a mean volume diameter of 75 nm was obtained in the same manner as in Manufacturing Example 1 of Pigment Dispersion except that carbon black was replaced with Hansa Brilliant Yellow 5GX03 (manufactured by Clariant AG).

### Manufacturing Example 5 of Pigment Dispersion

Preparation of Dispersion Element of White Pigment A total of 25 g of titanium oxide (STR-100W, manufactured by Sakai Chemical Industry Co., Ltd.), 5 g of pigment dispersant (TEGO Dispers 651, manufactured by Evonik Industries AG), and 70 g of water were mixed followed by dispersing using a bead mill (research labo, manufactured by Shinmaru Enterprises Corporation) with zirconia beads having a diameter of 0.3 mm and a filling ratio of 60 percent at 8 m/s for five minutes so that a white pigment dispersion having a mean volume diameter of 285 nm was obtained.

### Manufacturing Examples 1 to 9 of Ink

The following prescription shown in Tables 4 and 5 below was mixed and stirred. The non-white ink was filtered with a polypropylene filter having an average pore diameter of 0.2 μm and the white ink was filtered with a polypropylene filter having an average pore diameter of 0.5 μm to obtain Inks I-1 to I-9.

TABLE 4

| | | Ink No | | | | |
|---|---|---|---|---|---|---|
| | | I-1 | I-2 | I-3 | I-4 | I-5 |
| Pigment | Black pigment | 4 | 4 | 4 | 4 | 4 |
| dispersion | dispersion | | | | | |
| | Cyan pigment | | | | | |
| | dispersion | | | | | |
| | Magenta pigment | | | | | |
| | dispersion | | | | | |
| | Yellow pigment | | | | | |
| | dispersion | | | | | |
| | White pigment | | | | | |
| | dispersion | | | | | |
| Water-dispersible | Polyurethane | 15 | | | | |
| Resin | resin A (Tg: 41 | | | | | |
| | degrees C.) | | | | | |
| | Polyurethane | | 20 | | | |
| | resin B (Tg: −10 | | | | | |
| | degrees C.) | | | | | |
| | Acrylic resin A | | | 20 | | |
| | (Tg: 12 degrees | | | | | |
| | C.) | | | | | |
| | Styrene-acrylic | | | | 15 | |
| | resin A (Tg = | | | | | |
| | 50 degrees C.) | | | | | |
| | Polyester resin A | | | | | 10 |
| | (Tg: 67 degrees | | | | | |
| | C.) | | | | | |
| Organic solvent | 1,2-propane diol | 15 | 15 | 15 | 15 | |
| | 1,2-butanediol | | | | | 15 |
| | 3-methoxy-3- | 10 | 12 | 10 | 12 | 10 |
| | methyl-1-butanol | | | | | |
| Surfactant | FS-300 | 2 | 2 | 2 | 2 | 2 |
| Preservative | Proxel GXL | 0.05 | 0.05 | 0.05 | 0.05 | 0.05 |
| Defoaming | 2,4,7,9-tetramethyl | 0.5 | 0.5 | | | 0.4 |
| agent | decane-4,7-diol | | | | | |
| | 2,5,8,11-tetramethyl | | | 0.4 | 0.4 | |
| | dodecane-5,8-diol | | | | | |
| pH regulator | 2-amino-2-ethyl- | 0.2 | 0.2 | 0.2 | 0.1 | 0.2 |
| | 1,3-propane diol | | | | | |
| Water | Pure water | Balance | Balance | Balance | Balance | Balance |

| | | | | | |
|---|---|---|---|---|---|
| Total (percent by mass) | 100 | 100 | 100 | 100 | 100 |

TABLE 5

| | | Ink No. | | | |
|---|---|---|---|---|---|
| | | I-6 | I-7 | I-8 | I-9 |
| Pigment dispersion | Black pigment dispersion | | | | |
| | Cyan pigment dispersion | 4 | | | |
| | Magenta pigment dispersion | | 4 | | |
| | Yellow pigment dispersion | | | 4 | |
| | White pigment dispersion | | | | 7 |
| Water-dispersible | Urethane resin A (Tg: 41 degrees | 15 | | | |
| Resin | C.) | | | | |
| | Urethane resin B (Tg: −10 degrees | | | | |
| | C.) | | | | |
| | Acrylic resin A (Tg: 12 degrees C.) | | | | |
| | Styrene-acrylic resin A (Tg = 50 | | 15 | 15 | 15 |
| | degrees C.) | | | | |
| | Polyester resin A (Tg: 67 degrees | | | | |
| | C.) | | | | |
| Organic solvent | 1,2-propane diol | | | | |
| | 1,2-butanediol | 15 | 15 | 15 | 15 |
| | 3-methoxy-3-methyl-1-butanol | 12 | 12 | 12 | 12 |
| Surfactant | FS-300 | 2 | 2 | 2 | 2 |
| Preservative | Proxel GXL | 0.05 | 0.05 | 0.05 | 0.05 |
| Defoaming agent | 2,4,7,9-tetramethyl decane-4,7-diol | 0.4 | 0.4 | 0.4 | 0.4 |
| | 2,5,8,11-tetramethyl dodecane-5,8- | | | | |
| | diol | | | | |
| pH regulator | 2-amino-2-ethyl-1,3-propane diol | 0.2 | 0.2 | 0.2 | 0.2 |
| Water | Pure water | Balance | Balance | Balance | Balance |

| | | | | |
|---|---|---|---|---|
| Total (percent by mass) | 100 | 100 | 100 | 100 |

The details of the individual ingredients in Tables 4 and 5 are as follows:

Surfactant
FS-300 (fluorochemical surfactant, manufactured by E.I. du Pont de Nemours and Company) Resin
Urethane resin A: SUPERFLEX® 210, Tg of 41 degrees C., manufactured by DKS Co., Ltd.
Urethane resin B: SUPERFLEX® 420, Tg of −10 degrees C., manufactured by DKS Co., Ltd.
Acrylic resin A: VONCOAT CF-6140, Tg of 12 degrees C., manufactured by DIC CORPORATION
Styrene-acrylic resin A: Vinyblan 2685, Tg of 50 degrees C., manufactured by Nissin Chemical Industry Co., Ltd.
Polyester resin A: ELITEL® KA-5034, Tg of 67 degrees C., manufactured by UNITIKA LTD.

### Examples 9 to 16 and Comparative Examples 6 to 10

Set of Ink and Processing Liquid

The ink and processing liquid shown in Table 6 were combined as the sets of ink and processing liquid shown in Table 6. Images were formed in the following manner using each set of the ink and processing liquid shown in Table 6.

Image Formation

An inkjet printer (IPSiO Gxe 5500, manufactured by Ricoh Co., Ltd.) was filled with the ink of the set of ink and processing liquid shown in Table 6. A solid image of four color inks overlapped was printed on polyvinyl chloride (PVC) film (GIY11Z5, manufactured by LINTEC Corporation) on which the processing liquid had already been applied at a resolution of 1,200 dpi×1,200 dpi with the inkjet printer to form a solid image, followed by allowing to rest on a hot plate at 80 degrees C. for three minutes to obtain a dried image.

Properties of each of the obtained images were evaluated in the following manner. The results are shown in Table 7.

Evaluation on Image Density

The image density at the solid portion of each of the obtained images were measured by a spectrophotometric densitometr (X-Rite 939, manufactured by X-Rite Inc.). It was evaluated according to the following criteria. A- or B-rated image is usable for practical purpose.

Evaluation Criteria

A: Image density of 2.0 or higher
B: Image density of 1.5 to less than 2.0
B: Image density of 1.0 to less than 1.5
C: Image density of less than 1.0

Evaluation on Negative Garbled Character

A dried image sample was prepared by printing outline character of Gothic font with black ink in Image Formation described above. Legibility of the obtained characters was judged with naked eyes and evaluated according to the following criteria. A- or B-rated image is allowable for practical purpose.

Evaluation Criteria

S: 2 point Gothic character legible
A: 2 point Gothic character illegible but 3 point Gothic legible
B: 3 point Gothic character illegible but 4 point Gothic legible
C: 4 point Gothic character illegible but 5 point Gothic legible
D: 5 point Gothic character illegible

Evaluation on Abrasion Resistance

The solid image portion of each image obtained in Image Formation was abraded by dried cotton (unbleached muslin No. 3) under a load of 400 g to evaluate abrasion resistance according to the following criteria. A- or B-rated image is usable for practical purpose.

Evaluation Criteria

A: No change in image when abraded 100+ times
B: Slight scratch observed when abraded 100 times but causing no impact on image density
C: Image density degraded while abraded 100 times
D: Image density degraded while abraded 50− times

Evaluation on Drying

After a solid image was formed in the same conditions except for Image Formation and the drying condition, it was dried to obtain an image sample. The solid portion was pressed with a filter paper after drying. The drying property of the solid portion was evaluated according to the following criteria by the degree of transfer of ink to the filter paper. A- or B-rated image is usable for practical purpose.

Evaluation Criteria

A: Transfer of ink to filter paper stops on drying condition of 25 degrees C. for 15 minutes
B: Transfer of ink to filter paper stops on drying condition of 25 degrees C. for 30 minutes
C: Transfer of ink to filter paper stops on drying condition of 25 degrees C. for 60 minutes
D: Transfer of ink to filter paper continues after drying at 25 degrees C. for 60 minutes

TABLE 6

| | Set of ink and processing liquid | | | | | |
|---|---|---|---|---|---|---|
| | Processing | Black | Cyan | Magenta | Yellow | White |
| | liquid | ink | ink | ink | ink | Ink |
| Example 9 | Example 1 | I-1 | I-6 | I-7 | I-8 | I-9 |
| Example 10 | Example 2 | I-2 | I-6 | I-7 | I-8 | I-9 |
| Example 11 | Example 3 | I-3 | I-6 | I-7 | I-8 | I-9 |
| Example 12 | Example 4 | I-4 | I-6 | I-7 | I-8 | I-9 |
| Example 13 | Example 5 | I-5 | I-6 | I-7 | I-8 | I-9 |
| Example 14 | Example 6 | I-5 | I-6 | I-7 | I-8 | I-9 |
| Example 15 | Example 7 | I-1 | I-6 | I-7 | I-8 | I-9 |
| Example 16 | Example 8 | I-1 | I-6 | I-7 | I-8 | I-9 |
| Comparative | Comparative | I-1 | I-6 | I-7 | I-8 | I-9 |
| Example 6 | Example 1 | | | | | |
| Comparative | Comparative | I-1 | I-6 | I-7 | I-8 | I-9 |
| Example 7 | Example 2 | | | | | |
| Comparative | Comparative | I-1 | I-6 | I-7 | I-8 | I-9 |
| Example 8 | Example 3 | | | | | |
| Comparative | Comparative | I-1 | I-6 | I-7 | I-8 | I-9 |
| Example 9 | Example 4 | | | | | |
| Comparative | Comparative | I-1 | I-6 | I-7 | I-8 | I-9 |
| Example 10 | Example 5 | | | | | |

TABLE 7

| | Evaluation result | | | |
|---|---|---|---|---|
| | | Negative | | |
| | Image | garbled | Drying | Abrasion |
| | Density | characters | property | resistance |
| Example 9 | A | A | A | A |
| Example 10 | A | A | A | A |
| Example 11 | A | A | B | A |
| Example 12 | B | A | A | A |
| Example 13 | A | A | A | A |
| Example 14 | B | A | A | A |
| Example 15 | A | B | A | B |
| Example 16 | B | B | A | B |
| Comparative | C | C | B | B |
| Example 6 | | | | |
| Comparative | D | B | C | C |
| Example 7 | | | | |
| Comparative | C | B | C | D |
| Example 8 | | | | |
| Comparative | C | D | D | C |
| Example 9 | | | | |
| Comparative | C | D | D | C |
| Example 10 | | | | |

Aspects of the present disclosure are, for example, as follows.

1. A processing liquid contains a nonionic resin, resin particles having a carboxylic acid group, a flocculant, and an organic solvent, and water.

2. The processing liquid according to 1 mentioned above, wherein the nonionic resin contains nonionic resin particles containing at least one member selected from the group consisting of polyolefin resin, polyvinyl acetate resin, polyvinyl chloride resin, polyurethane resin, styrene-butadiene resin, and a copolymer thereof.

3. The processing liquid according to 1 or 2 mentioned above, wherein the glass transition temperature of the nonionic resin is from −30 to 30 degrees C.

4. The processing liquid according to any one of 1 to 3 mentioned above, wherein the proportion of the nonionic resin in the processing liquid is from 0.5 to 20 percent by mass.

5. The processing liquid according to any one of 1 to 4 mentioned above, wherein the flocculant contains a cationic polymer copolymerized from an amine and a monomer containing epihalohydrin.

6. A set of ink and processing liquid contains the processing liquid of any one of 1 to mentioned above and the ink containing at least one of white ink and non-white ink.

7. The set according to 6 mentioned above, wherein the white ink contains a white coloring material and thermoplastic resin particles.

8. A method of printing includes applying the processing liquid of the set of ink and processing liquid of 6 or 7 mentioned above to a substrate and applying the ink of the set of ink and processing liquid of 6 or 7 mentioned above.

9. The method according to 8 mentioned above, wherein the processing liquid and the ink are applied by inkjetting.

10. A printing device includes a processing liquid application device configured to apply the processing liquid of the set of 6 or 7 mentioned above to a substrate and an ink application device configured to apply the ink of the set.

11. The printing device according to 10 mentioned above, wherein the processing liquid and the ink are applied by inkjetting.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A processing liquid comprising:
a nonionic resin;
a resin particle having a carboxylic acid group;
a flocculant;
an organic solvent; and
water.

2. The processing liquid according to claim 1, wherein the nonionic resin comprises nonionic resin particles comprising at least one member selected from the group consisting of polyolefin resin, polyvinyl acetate resin, polyvinyl chloride resin, polyurethane resin, styrene-butadiene resin, and a copolymer thereof.

3. The processing liquid according to claim 1, wherein the nonionic resin has a glass transition temperature of from −30 to 30 degrees C.

4. The processing liquid according to claim 1, wherein a proportion of the nonionic resin in the processing liquid is from 0.5 to 20 percent by mass.

5. The processing liquid according to claim 1, wherein the flocculant comprises a cationic polymer copolymerized from an amine and a monomer containing epihalohydrin.

6. A set comprising:
the processing liquid of claim 1; and
an ink comprising at least one of white ink and non-white ink.

7. The set according to claim 6, wherein the white ink comprises a white coloring material and thermoplastic resin particles.

8. A method of printing comprising:
applying the processing liquid of the set of claim 6 to a substrate; and
applying the ink of the set.

9. The method according to claim 8, wherein the processing liquid and the ink are applied by inkjetting.

10. A printing device comprising:
a processing liquid application device configured to apply the processing liquid of the set of claim 6 to a substrate; and
an ink application device configured to apply the ink of the set.

11. The printing device according to claim 10, wherein the processing liquid and the ink are applied by inkjetting.
